(19) United States
(12) Patent Application Publication
(10) Pub. No.: US 2015/0244467 A1
(43) Pub. Date: Aug. 27, 2015

(54) OPTICAL TRANSMISSION DEVICE AND OPTICAL RECEPTION DEVICE

(71) Applicant: NEC Corporation, Tokyo (JP)

(72) Inventor: Makoto SHIBUTANI, Tokyo (JP)

(21) Appl. No.: 14/624,798

(22) Filed: Feb. 18, 2015

(30) Foreign Application Priority Data
Feb. 26, 2014 (JP) 2014-035237

(51) Int. Cl. H04B 10/548; H04B 10/40; H04B 10/61

(52) U.S. Cl. CPC H04B 10/548; H04B 10/616; H04B 10/40

(57) ABSTRACT

An optical transmission device includes a division unit that divides transmission data into a plurality of data and outputs the plurality of data, a frequency conversion unit that shifts a frequency band of the divided transmission data so that the frequency bands of the divided transmission data do not overlap each other and outputs the divided transmission data whose frequency band is shifted as a modulation signal, and an optical modulation unit that modulates an optical carrier with a signal in which the modulation signals are added and outputs the modulated optical carrier as a signal light.

This application is based upon and claims the benefit of priority from Japanese Patent Application No. 2014-035237, filed on Feb. 26, 2014, the disclosure of which is incorporated herein in its entirety by reference.

### TECHNICAL FIELD

The present invention relates to an optical transmission device and an optical reception device and in particular, relates to an optical transmission device and an optical reception device used in an optical transmission system using a digital coherent optical transmission method.

### BACKGROUND ART

In recent years, with an increase in the demand for data communication services, a large-capacity optical fiber communication system which uses a digital coherent optical transmission method and a dense wavelength division multiplexing transmission method is introduced. Further, a polarization multiplexing method by which a signal light is generated by multiplexing the optical carriers with orthogonal polarizations is being developed.

FIG. 6 shows a block diagram showing a configuration of an optical transmission-reception device 90 according to the related art of the present invention. The optical transmission-reception device 90 has a function for coherent optical transmission. The optical transmission-reception device 90 includes a framer 70, signal processing circuits 900 and 901, optical modulators (Optical Mods) 400 and 401, optical receivers (Optical Rxs) 500 and 501, transmission light sources 410 and 411, and local light sources 510 and 511.

In FIG. 6, transmission data 20 inputted to the optical transmission-reception device 90 is divided into two data: transmission data 30 and transmission data 31 by the framer 70. The divided transmission data 30 and 31 are inputted to the signal processing circuits 900 and 901, respectively.

In the signal processing circuit 900, the transmission data 30 is coded so that the transmission data 30 is consistent with a modulation scheme of the optical modulator 400. The coded transmission data 30 is outputted as a modulation signal 980. Similarly, in the signal processing circuit 901, the transmission data 31 is coded so that the transmission data 31 is consistent with a modulation scheme of the optical modulator 401. The coded transmission data 31 is outputted as a modulation signal 981.

The modulation signal 980 is inputted to the optical modulator 400. The optical modulator 400 modulates an optical carrier wave (carrier) inputted from the transmission light source 410 with the modulation signal 980 and outputs the modulated carrier to an optical transmission path as a signal light 940. Similarly, the modulation signal 981 is inputted to the optical modulator 401. The optical modulator 401 modulates the carrier inputted from the transmission light source 411 with the modulation signal 981 and outputs the modulated carrier to the optical transmission path as a signal light 941.

On the other hand, the optical transmission-reception device 90 receives signal lights 950 and 951 from the optical transmission path. A coherent reception process is performed to the signal light 950 in the optical receiver 500. That is, the signal light 950 is converted into a reception signal 990 by mixing the signal light 950 with a local light inputted from the local light source 510 in the optical receiver 500. The reception signal 990 is inputted to the signal processing circuit 900. In the signal processing circuit 900, a well-known signal equalization process such as a wavelength dispersion compensation process or the like is performed to the reception signal 990 and then, the reception signal 990 is demodulated into a reception data 60. The demodulated reception signal 990 is outputted to the framer 70 as the reception data 60.

The reception process that is the same as the reception process applied to the signal light 950 is performed to the signal light 951. The signal light 951 is converted into a reception signal 991 by the optical receiver 501 and the local light source 511. The reception signal 991 is inputted to the signal processing circuit 901. In the signal processing circuit 901, the well-known signal equalization process such as the wavelength dispersion compensation process or the like is performed to the reception signal 991 and then, the reception signal 991 is demodulated into a reception data 61. The demodulated reception signal 991 is outputted to the framer 70 as the reception data 61.

The framer 70 couples the reception data 60 with the reception data 61 and outputs the coupled data as reception data 80.

As the related art of the present invention, Japanese Patent Application Laid-Open No. 2009-188510 (patent literature 1) and Japanese Patent Application Laid-Open No. 2008-206063 (patent literature 2) are known.

In paragraphs [0016] to [0024] of patent literature 1, there is described an optical communication device for transmitting a signal light phase-modulated with an orthogonal frequency division multiplexing (OFDM) signal.

In paragraphs [0019] to [0029] of patent literature 2, there is described an optical transmission device for transmitting a carrierless SSB (single side band) optical signal.

As explained by using FIG. 6, a conventional optical transmission-reception device for the transmission of a coherent light includes an optical modulator and a coherent optical receiver that are used for transmitting and receiving the carrier for each carrier. Therefore, in the optical transmission-reception device which transmits and receives a plurality of carriers, the number of the optical modulators has to be equal to the number of the transmitted carriers and the number of the coherent optical receivers has to be equal to the number of the received carriers.

That is, in the optical transmission-reception device 90 shown in FIG. 6, two optical modulators and two coherent optical receivers are required for transmitting and receiving two carriers. For this reason, the optical transmission-reception device 90 shown in FIG. 6 has a problem in which an accommodation efficiency that is proportional to the number of wavelengths of the lights transmitted/received by one optical transmission-reception device is low, the size of the optical transmission-reception device cannot be reduced, and the price of the optical transmission-reception device cannot be reduced. In patent literatures 1 and 2, a technology to solve the problem in which the accommodation efficiency is low and whereby, it is difficult to reduce the size and price of the optical transmission-reception device is not shown.

### SUMMARY

An exemplary object of the invention is to provide an optical transmission device and an optical reception device which can transmit a plurality of carriers in a simple configuration.

An optical transmission device according to an exemplary aspect of the invention includes a division unit that divides transmission data into a plurality of data and outputs the plurality of data, a frequency conversion unit that shifts a frequency band of the divided transmission data so that the frequency bands of the divided transmission data do not overlap each other and outputs the divided transmission data whose frequency band is shifted as a modulation signal, and an optical modulation unit that modulates an optical carrier with a signal in which the modulation signals are added and outputs the modulated optical carrier as a signal light.

An optical reception device according to an exemplary aspect of the invention includes an optical reception unit that performs coherent reception by mixing signal lights in which divided transmission data are included in different optical carriers with a local light and outputs a reception signal, a frequency conversion unit that extracts each of the divided transmission data included in the reception signal for each frequency band in which each of the divided transmission data is included and outputs the extracted divided transmission data as reception data, and a coupling unit that generates the transmission data by coupling the extracted reception data with each other.

An optical transmission method according to an exemplary aspect of the invention includes dividing transmission data into a plurality of data and outputting the plurality of data, shifting frequency bands of the divided transmission data so that the frequency bands do not overlap each other, outputting the divided transmission data whose frequency band is shifted as a modulation signal, modulating an optical carrier with a signal in which the modulation signals are added, and outputting the modulated optical carrier as a signal light.

By using the optical transmission device and the optical reception device of the present invention, a plurality of carriers can be transmitted in a simple configuration.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of an optical transmission-reception device according to a first exemplary embodiment,

FIG. 2 is a block diagram showing a configuration of a signal processing circuit,

FIG. 3A is a figure showing a spectrum of a modulation signal,

FIG. 3B is a figure showing a spectrum of a modulation signal,

FIG. 3C is a figure showing a spectrum of a modulation signal,

FIG. 4 is a figure showing an example of a polarization and wavelength allocation of a transmitted signal light and a received signal light,

FIG. 5A is a figure showing an example of a frequency spectrum of a reception signal,

FIG. 5B is a figure showing an example of a frequency spectrum of a reception signal,

FIG. 5C is a figure showing an example of a frequency spectrum of a reception signal, and

FIG. 6 is a block diagram showing a configuration of an optical transmission-reception device according to the related art of the present invention.

### EXEMPLARY EMBODIMENT

### First Exemplary Embodiment

In a first exemplary embodiment, an optical transmission-reception device used in an optical transmission system in which a digital coherent optical transmission method is employed will be described. The optical transmission-reception device according to the first exemplary embodiment can transmit and receive the signal light including two carriers by a set of an optical modulator and a coherent optical receiver.

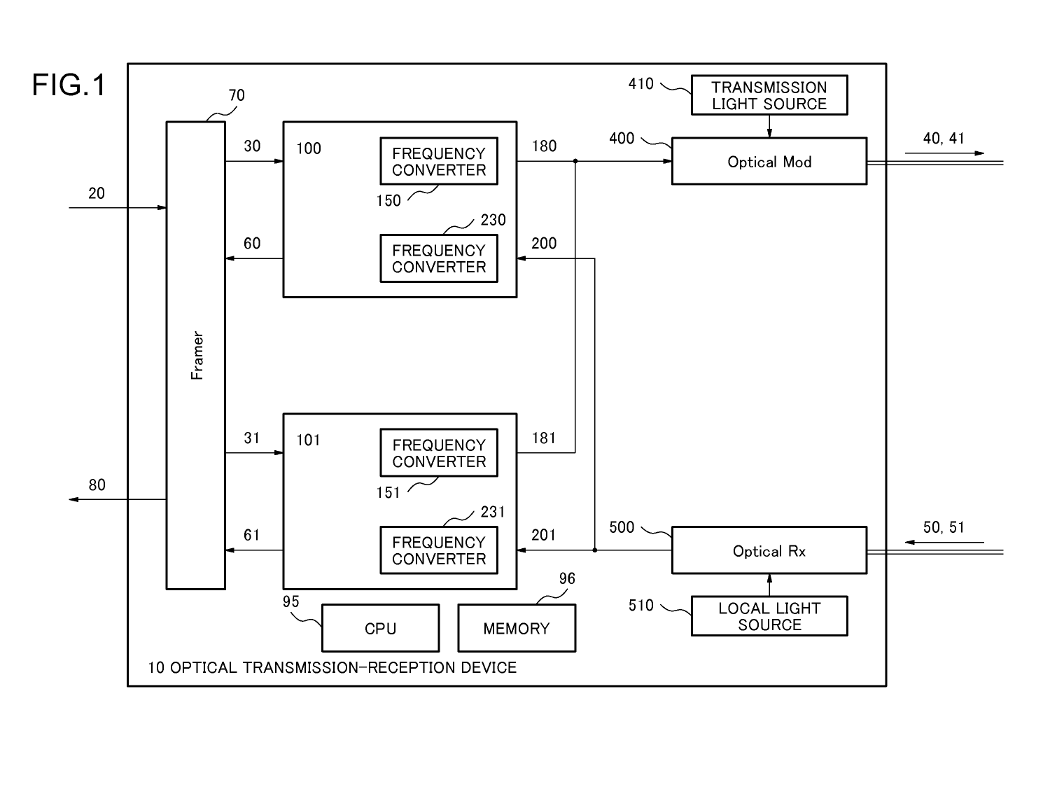

FIG. 1 is a block diagram showing a configuration of an optical transmission-reception device 10 according to the first exemplary embodiment of the present invention. The optical transmission-reception device 10 has a transmission function and a reception function for the transmission of a coherent light. The optical transmission-reception device 10 includes a framer 70, signal processing circuits 100 and 101, an optical modulator 400, an optical receiver 500, a transmission light source 410, and a local light source 510. The optical transmission-reception device 10 may further include a CPU (central processing unit) 95 and a memory 96. The memory 96 is, for example, a non-volatile semiconductor memory and stores a program for operating the CPU 95. The memory 96 is a non-transitory recording medium.

The framer 70 is a division circuit which divides inputted transmission data 20 into two data: transmission data 30 and transmission data 31 and outputs these data. Further, the framer 70 is a coupling circuit which couples reception data 60 with reception data 61 and outputs the coupled data as reception data 80. A procedure of dividing the transmission data 20 in the framer 70 is not limited in particular. The division procedure used in the framer 70 is a procedure in which the optical receiver which can receive the signal light including the divided transmission data 30 and 31 can restore the transmission data 20 by coupling the demodulated transmission data 30 with the demodulated transmission data 31.

The signal processing circuit 100 includes frequency converters 150 and 230. The signal processing circuit 101 includes frequency converters 151 and 231. Operation of the signal processing circuits 100 and 101 will be described in detail later.

The transmission data 20 inputted to the optical transmission-reception device 10 is divided into two: the transmission data 30 and the transmission data 31 by the framer 70. The transmission data 30 and 31 are inputted to the signal processing circuits 100 and 101, respectively. In this exemplary embodiment, the data speed of the transmission data 20 is 200 Gbps, the data speed of the transmission data 30 is 100 Gbps, and the data speed of the transmission data 31 is 100 Gbps.

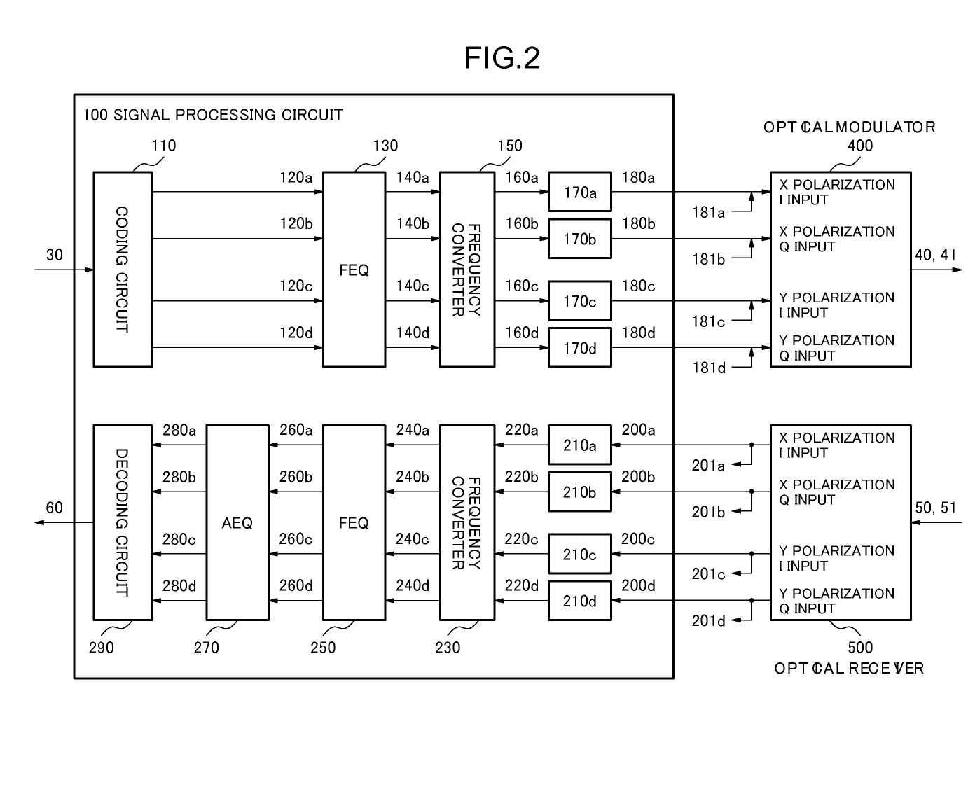

FIG. 2 is a block diagram showing a configuration of the signal processing circuit 100. In FIG. 2, the signal processing circuit 100 is connected to the optical modulator 400 and the optical receiver 500. The signal processing circuit 101 has a configuration that is the same as that of the signal processing circuit 100. The configuration of the signal processing circuit 100 will be described below.

The signal processing circuit 100 includes a coding circuit 110, a fixed equalization circuit (FEQ) 130, the frequency converter 150, and digital to analog (DA) converters 170a to 170d. The signal processing circuit 100 further includes analog to digital (AD) converters 210a to 210d, the frequency converter 230, a fixed equalization circuit 250, an adaptive equalization circuit (AEQ) 270, and a decoding circuit 290.

The coding circuit 110 codes the transmission data 30 so that the transmission data 30 is consistent with a polarization multiplexing quadrature phase shift keying (QPSK) modulation scheme. By the coding, the transmission data 30 is converted into four lanes of modulation signals 120a to 120d. The modulation signals 120a to 120d are a signal corresponding to an I (inphase) axis of X polarization (XI signal), a signal corresponding to a Q (quadrature) axis of X polarization (XQ signal), a signal corresponding to an I axis of Y polarization (YI signal), and a signal corresponding to a Q axis of Y polarization (YQ signal) for the polarization multiplexing QPSK modulation scheme, respectively. X polarization is orthogonal to Y polarization.

A signal speed (baud rate) is 25 Gbaud for the XI signal, the XQ signal, the YI signal, and the YQ signal. The fixed equalization circuit 130 performs a process such as a spectrum shaping process and the like to the modulation signals 120a to 120d and outputs the processed signals to the frequency converter 150 as modulation signals 140a to 140d.

The frequency converter 150 shifts frequency bands of the modulation signals 120a to 120d to a low frequency side by 12.5 GHz. The modulation signals whose frequency bands are shifted are outputted to the DA converters 170a to 170d as modulation signals 160a to 160d, respectively. The DA converters 170a to 170d convert the modulation signals 160a to 160d into analog modulation signals 180a to 180d, respectively.

The modulation signals 180a to 180d are frequency-multiplexed with modulation signals 181a to 181d, respectively and the frequency-multiplexed signals are inputted to the optical modulator 400. An adder circuit may be used for multiplexing the modulation signals 180a to 180d with the modulation signals 181a to 181d. In this exemplary embodiment, the optical modulator 400 has a polarization multiplexing QPSK modulation function. The transmission light source 410 generates an optical carrier wave (carrier) having a single wavelength by using a semiconductor laser. That is, the optical modulator 400 modulates the career outputted from the transmission light source 410 with the inputted modulation signals 180a to 180d and 181a to 181d by using the polarization multiplexing QPSK modulation and outputs the modulated carriers as signal lights 40 and 41.

Each of the coding circuit 110, the fixed equalization circuit 130, the DA conversion circuits 170a to 170d, the transmission light source 410, and the optical modulator 400 has a configuration that is the same as the configuration of the elements composed of a conventional optical transmission device for digital coherent light transmission and operates like the element of the conventional optical transmission device. Therefore, the detailed description of these elements will be omitted.

The modulation signals 181a to 181d are output signals of the signal processing circuit 101 in which the transmission data 31 shown in FIG. 1 is processed like the transmission data 30 in the signal processing circuit 100. However, the frequency bands of the modulation signals 181a to 181d are shifted to a high frequency side by 12.5 GHz by the frequency converter 151 provided in the signal processing circuit 101. This is a difference between the modulation signals 180a to 180d and the modulation signals 181a to 181d.

Further, in this specification and drawings, hereinafter, reception signals 200a to 200d may be referred to by a generic name of “reception signal 200”. Similarly, the other signals may be referred to by a generic name.

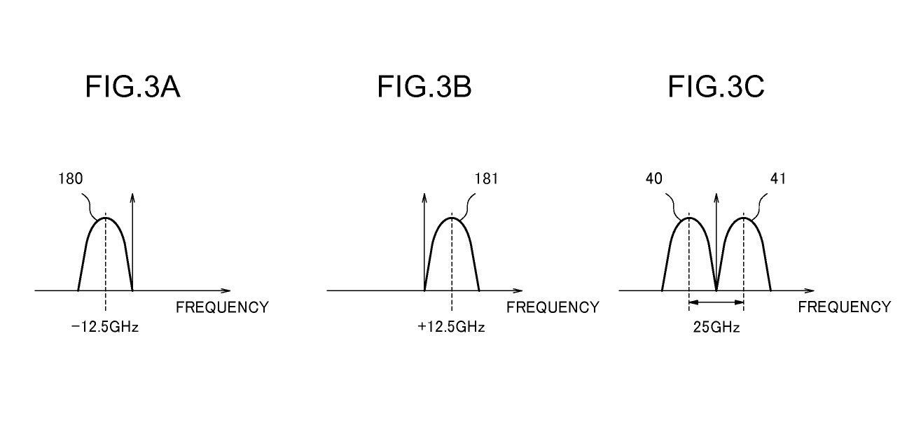

FIG. 3A to FIG. 3C are a figure showing a spectrum of the modulation signal. FIG. 3A shows a frequency spectrum of the modulation signal 180. FIG. 3B shows a frequency spectrum of the modulation signal 181. The bandwidth of the modulation signal 180 is approximately 25 GHz. The frequency band of the modulation signal 180 is shifted to a low frequency side by the frequency converter 150 so that the center frequency of the modulation signal 180 is shifted to a low frequency side by 12.5 GHz. On the other hand, the bandwidth of the modulation signal 181 is approximately 25 GHz. The frequency band of the modulation signal 181 is shifted to a high frequency side so that the center frequency of the modulation signal 181 is shifted to a high frequency side by 12.5 GHz. Accordingly, as shown in FIG. 3C, when the modulation signal 180 and the modulation signal 181 are added, the spectrum of the modulation signal 180 and the spectrum of the modulation signal 181 do not overlap each other, each spectrum has a peak, and the frequency difference between the peaks of the both spectrums is 25 GHz. The modulation signal with the spectrum shown in FIG. 3C is inputted to the optical modulator 400.

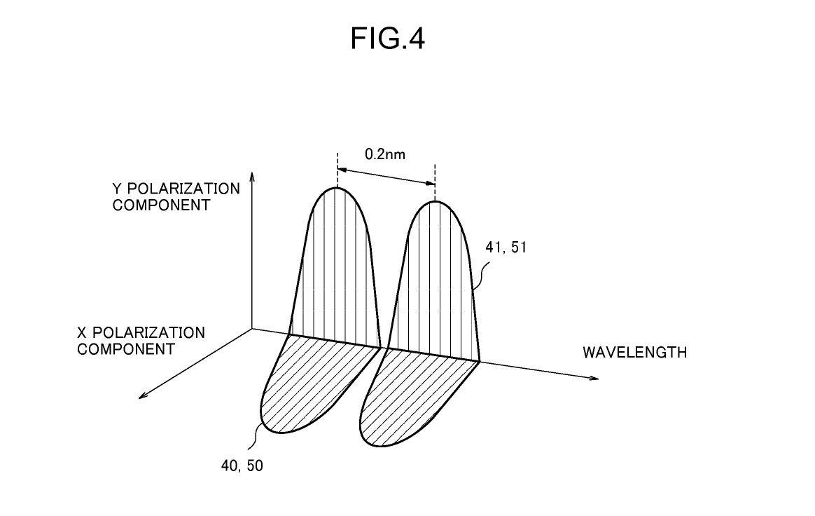

FIG. 4 is a figure showing an example of the polarization and wavelength allocation of the signal lights 40 and 41 transmitted by the optical transmission-reception device 10, and the signal lights 50 and 51 received by the optical transmission-reception device 10. When each of the signal lights 40 and 41 has a wavelength of 1550 nm, the center frequency difference between the modulation signal 180 and the modulation signal 181 is 25 GHz. This corresponds to a wavelength interval of 0.2 nm. Accordingly, when the optical modulator 400 is driven with the signal obtained by adding the modulation signal 180 and the modulation signal 181, the signal light in which two carriers (the signal lights 40 and 41) are multiplexed with the wavelength interval of 0.2 nm as shown in FIG. 4 (a super channel signal) is transmitted.

Next, a reception operation of the optical transmission-reception device 10 will be described. For example, the optical receiver 500 is a photoelectric conversion circuit that includes a 90 degree optical hybrid circuit and a photodiode and is used for digital coherent optical transmission. The optical receiver 500 mixes the received signal lights 50 and 51 with the local light outputted from the local light source and generates the reception signal 200. A configuration of the photoelectric conversion circuit used for digital coherent optical transmission is well-known. Therefore, the detailed description of the optical receiver 500 will be omitted.

In this exemplary embodiment, the optical receiver 500 converts the received signal lights 50 and 51 into the reception signals: a signal corresponding to an I axis of X polarization (XI), a signal corresponding to a Q axis of X polarization (XQ), a signal corresponding to an I axis of Y polarization (YI), and a signal corresponding to a Q axis of Y polarization (YQ) of the 90 degree optical hybrid circuit.

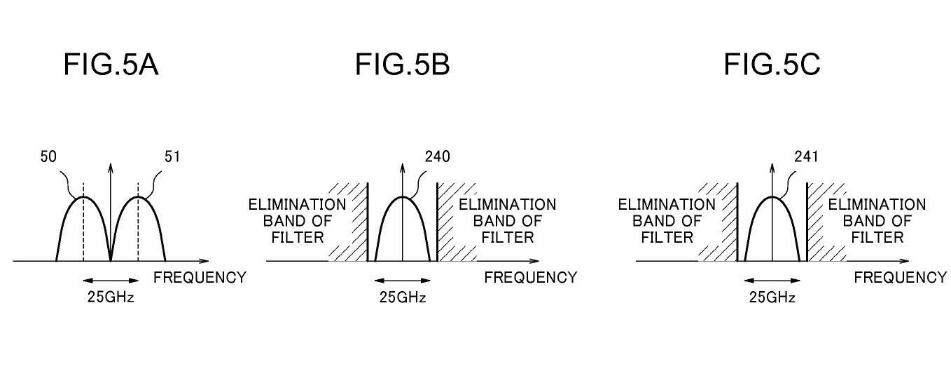

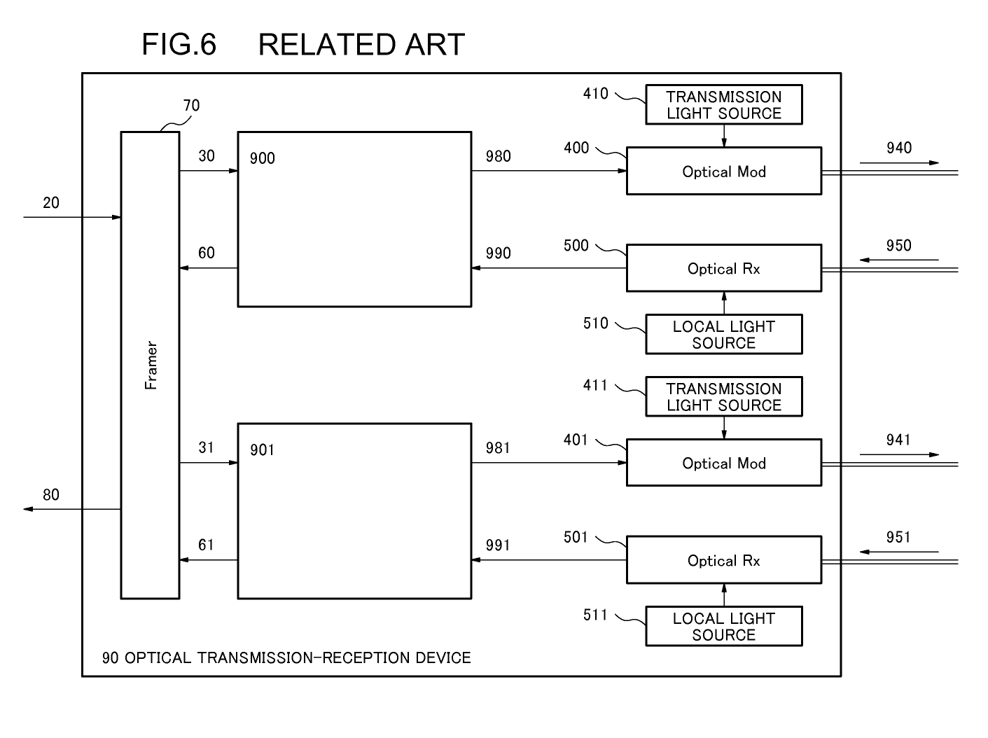

FIG. 5 is a figure showing an example of a frequency spectrum of the reception signal. The signal lights 50 and 51 in which two carriers are multiplexed with the wavelength interval of 0.2 nm (the frequency interval is 25 GHz) are received from the optical transmission path. The signal lights 50 and 51 are the super channel signal transmitted from the optical transmission device having a transmission function that is the same as that of the optical transmission-reception device 10. That is, the signal lights 50 and 51 are generated as follows: in the optical transmission device, the transmission data of 100 Gbps is converted into the parallel data of 25 Gbaud, the parallel data are modulated by using a polarization multiplexing QPSK modulation scheme, and the modulated signal is transmitted to the receiver as the signal lights 50 and 51.

FIG. 5A to FIG. 5C show an example of a spectrum of the reception signal 200 outputted from the optical receiver 500. In FIG. 5A, the center wavelength of the reception signal corresponding to the signal light 50 is located at a position shifted to a low frequency side by 12.5 GHz. The center wavelength of the reception signal corresponding to the signal light 51 is located at a position shifted to a high frequency side by 12.5 GHz. The interval between these center wavelengths is 25 GHz.

The reception signal 200 outputted from the optical receiver 500 is an analog electric signal and divided into two branched signals. One of the branched reception signals is inputted to the signal processing circuit 100 as the reception signal 200. The other of the branched reception signals is inputted to the signal processing circuit 101 as a reception signal 201.

In the signal processing circuit 100, the analog to digital (AD) converter 210 converts the reception signal 200 into a digital signal and outputs the digital signal as a reception signal 220. The frequency converter 230 shifts a frequency of the reception signal 220 to a high frequency side by 12.5 GHz. Further, only the signal in a frequency range between −12.5 GHz and +12.5 GHz passes through the frequency converter 230 and a signal in other than the frequency range is eliminated by a filtering process of the frequency converter 230. As a result, as shown in FIG. 5B, when the reception signal corresponding to the signal light 50 is inputted to the frequency converter 230, the frequency converter 230 outputs a reception signal 240 of which the center frequency is zero and the frequency bandwidth is 25 GHz.

The fixed equalization circuit 250 performs the fixed signal equalization process such as wavelength dispersion compensation, filtering, or the like to the reception signal 240 and outputs the processed signal as a reception signal 260.

The adaptive equalization circuit 270 performs an adaptive signal equalization process such as polarization dispersion compensation, polarization splitting, frequency offset compensation, or the like to the reception signal 260 and outputs the processed signal as a reception signal 280.

The decoding circuit 290 decodes the reception signal 280 and outputs the decoded signal as the reception data 60.

Further, each of the AD converter 210, the fixed equalization circuit 250, the adaptive equalization circuit 270, and the decoding circuit 290 has a configuration that is the same as the configuration of the elements composed of a conventional optical receiver for digital coherent optical transmission and the procedures of the process performed in each of the above-mentioned elements are the same as those performed in the elements composed of a conventional optical receiver for digital coherent optical transmission. Therefore, the detailed description will be omitted.

The signal processing circuit 101 performs the process that is the same as the process performed by the signal processing circuit 100 to the reception signal 201. The signal processing circuit 101 outputs the reception data 61. However, the frequency converter 231 of the signal processing circuit 101 shifts the frequency of the reception signal 201 to a low frequency side by 12.5 GHz. By the process of the signal processing circuit 101, the signal included in the signal light 51 is outputted as the reception data 61. The reception data 60 and 61 are multiplexed with each other by the framer 70 and the multiplexed data is outputted as the reception data 80.

As described above, in the optical transmission-reception device 10 according to the first exemplary embodiment, the frequency converters 150 and 151 provided in the signal processing circuits 100 and 101 shift the frequency bands of the modulation signals 140 and 141 so that both the frequency bands do not overlap each other, respectively. The modulation signals whose frequency bands are shifted are multiplexed with each other, the carrier is modulated with the multiplexed signal, and whereby, the optical transmission-reception device 10 according to the first exemplary embodiment can transmit the super channel signal shown in FIG. 4 in which two carriers are multiplexed with each other.

In the optical transmission-reception device 10 according to the first exemplary embodiment, the frequency converters 230 and 231 provided in the signal processing circuits 100 and 101 extract the reception data 60 and 61 for each carrier from the received super channel signal, respectively. Demodulation to the received super channel signal is performed in this way. The optical transmission-reception device 10 generates the reception data 80 from the demodulated reception data 60 and 61.

That is, the optical transmission-reception device 10 according to the first exemplary embodiment can transmit and receive the super channel signal in which two carriers are multiplexed with each other shown in FIG. 4 by using one optical transmission-reception device.

Thus, the optical transmission-reception device 10 according to the first exemplary embodiment can transmit a plurality of carriers in a simple configuration.

Further, in this exemplary embodiment, each of the modulation schemes used for the signal lights 40, 41, 50, and 51 is the polarization multiplexing QPSK modulation. However, the modulation scheme described in this exemplary embodiment is shown as an example.

Therefore, the modulation scheme used in the optical modulator 400 and the modulation scheme for the signal light received by coherent optical reception in the optical receiver 500 are not limited in particular. The data speed of the transmission data 20 and the baud rate of the modulation signal 120 coded by the coding circuit are not limited to the values described in this exemplary embodiment.

The above-mentioned function of the optical transmission-reception device 10 may be realized by using a program which causes the CPU 95 to control each unit of the optical transmission-reception device 10. The program is recorded in the memory 96. The memory 95 is a tangible and non-transitory recording medium for recording the program.

### Second Exemplary Embodiment

As a second exemplary embodiment, an optical transmission device including only the framer 70, the frequency converters 150 and 151, and the optical modulator 400 can be configured based on the configuration of the optical transmission-reception device 10 shown in FIG. 1. That is, the framer 70 (division unit) divides the transmission data into a plurality of data and outputs the plurality of data. The frequency converters 150 and 151 (frequency conversion units) shift the frequency bands of the transmission data divided by the framer 70 so that the frequency bands of the transmission data do not overlap each other and output the transmission data whose frequency bands are shifted as the modulation signals. The optical modulator 400 (optical modulation unit) modulates the optical carrier with the signal in which the modulation signals are added and outputs the modulated optical carrier as the signal light.

The optical transmission device according to the second exemplary embodiment that has the above-mentioned configuration modulates the optical carrier with the modulation signal in which the frequency bands of the divided transmission data do not overlap each other and generates the signal light. As a result, the optical transmission device according to the second exemplary embodiment can transmit the signal lights (super channel signal) in which the optical carriers, which are provided for the respective divided transmission data, are multiplexed. Accordingly, the optical transmission device according to the second exemplary embodiment can transmit a plurality of carriers in a simple configuration.

### Third Exemplary Embodiment

As a third exemplary embodiment, an optical reception device including only the optical receiver 500, the frequency converters 230 and 231, and the framer 70 can be configured based on the configuration of the optical transmission-reception device 10 shown in FIG. 1. That is, the optical receiver 500 (optical reception unit) receives the signal lights in which the divided transmission data are included in the different optical carriers. That is, each of a plurality of optical carriers includes the different divided transmission data. The optical receiver 500 performs coherent reception of the signal light by mixing the received signal light with the local light and outputs the reception signal. The frequency converters 230 and 231 extract the divided transmission data included in the reception signal outputted from the optical receiver 500 for each frequency band in which each of the divided transmission data is included and output it as the reception data. Further, the framer 70 couples the extracted reception data with each other and generates the transmission data.

The optical reception device according to the third exemplary embodiment that has the above-mentioned configuration receives the signal lights in which the optical carriers provided for the respective divided transmission data are multiplexed (super channel signal) and extracts the reception data for each frequency band. The optical reception device according to the third exemplary embodiment can restore the transmission data by coupling the reception data with each other. Accordingly, the optical reception device according to the third exemplary embodiment can transmit a plurality of carriers in a simple configuration.

Further, an optical transmission-reception device can be realized by installing the optical transmission device according to the second exemplary embodiment and the optical reception device according to the third exemplary embodiment in one chassis. It is clear that such optical transmission-reception device can transmit and receive a plurality of carriers in a simple configuration.

Further, the optical transmission system can be configured by arranging two optical transmission-reception devices 10 according to the first exemplary embodiment so as to face to each other. One of the optical transmission-reception devices transmits the signal lights 40 and 41 shown in FIG. 4 to the other of the optical transmission-reception devices. The signal lights 40 and 41 are received by the other of the optical reception devices as the signal lights 50 and 51. In such optical transmission system, the wavelength multiplexed signal light can be transmitted by using one set of the optical transmission-reception device. That is, the optical transmission system in which the optical transmission-reception devices 10 according to the first exemplary embodiment are arranged so as to face to each other can transmit a plurality of carriers in a simple configuration.

Further, the optical transmission system in which the signal light transmitted by the optical transmission device according to the second exemplary embodiment is received by the optical reception device according to the third exemplary embodiment can also transmit a plurality of carriers in a simple configuration.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, the exemplary embodiment of the present invention can be described as shown in the following supplementary note. However, the present invention is not limited to the following supplementary note.

(Supplementary Note 1)

An optical transmission device including:

a division unit that divides transmission data into a plurality of data and outputs the plurality of data;

a frequency conversion unit that shifts a frequency band of the divided transmission data so that the frequency bands of the divided transmission data do not overlap each other and outputs the divided transmission data whose frequency band is shifted as a modulation signal; and

an optical modulation unit that modulates an optical carrier with a signal in which the modulation signals are added and outputs the modulated optical carrier as a signal light.

(Supplementary Note 2)

The optical transmission device described in supplementary note 1 further including a coding unit that converts the divided transmission data into a signal corresponding to a modulation scheme of the optical modulation unit and outputs the converted signal to the frequency conversion unit, wherein

the coding unit generates a XI (inphase) signal corresponding to a first polarization X, a XQ (quadrature) signal whose phase is orthogonal to the phase of the XI signal, a YI signal corresponding to a second polarization Y orthogonal to the first polarization X, and a YQ signal whose phase is orthogonal to the phase of the YI signal and outputs these signals to the frequency conversion unit, and

a modulation scheme of the optical modulation unit is a polarization multiplexing phase modulation scheme in which X and Y polarizations are multiplexed each other.

(Supplementary Note 3)

An optical reception device comprising:

an optical receiver that performs coherent reception by mixing signal lights in which divided transmission data are included in different optical carriers with a local light and outputs a reception signal;

a frequency conversion unit that extracts each of the divided transmission data included in the reception signal for each frequency band in which each of the divided transmission data is included and outputs the extracted divided transmission data as reception data; and

a coupling unit that generates the transmission data by coupling the extracted reception data with each other.

(Supplementary Note 4)

The optical reception device described in supplementary note 3 further including a decoding unit that decodes the signal outputted by the frequency conversion unit and generates the divided transmission data wherein the optical receiver has a function to demodulate a polarization multiplexed phase modulation signal and outputs a XI′ (inphase) signal corresponding to a first polarization X′, a XQ′ (quadrature) signal whose phase is orthogonal to the phase of the XI′ signal, a YI′ signal corresponding to a second polarization Y′ orthogonal to the polarization X′, and a YQ′ signal whose phase is orthogonal to the phase of the YI′ signal to the frequency conversion unit as the reception signal.

(Supplementary Note 5)

An optical transmission-reception device including the optical transmission device described in supplementary note 1 or supplementary note 2 and the optical reception device described in supplementary note 3 or supplementary note 4.

(Supplementary Note 6)

An optical transmission system in which the optical transmission-reception devices described in supplementary note 5 are arranged so as to face to each other, one of the optical transmission-reception devices transmits a signal light to the other of the optical transmission-reception devices, and the other of the optical transmission-reception devices receives the signal light.

(Supplementary Note 7)

An optical transmission system having a configuration in which the signal light transmitted by the optical transmission device described in supplementary note 1 is received by the optical reception device described in supplementary note 3.

(Supplementary Note 8)

An optical transmission system having a configuration in which the signal light transmitted by the optical transmission device described in supplementary note 2 is received by the optical reception device described in supplementary note 4.

(Supplementary Note 9)

An optical transmission method including:

dividing transmission data into a plurality of data and outputting the plurality of data;

shifting frequency bands of the divided transmission data so that the frequency bands do not overlap each other;

outputting the divided transmission data whose frequency band is shifted as a modulation signal;

modulating an optical carrier with a signal in which the modulation signals are added; and

outputting the modulated optical carrier as a signal light.

(Supplementary Note 10)

An optical reception method including:

performing coherent reception by mixing signal lights in which divided transmission data are included in different optical carriers with a local light and outputting a reception signal;

extracting each of the divided transmission data included in the reception signal for each frequency band in which each of the divided transmission data is included and outputting the extracted divided transmission data as reception data; and

coupling the extracted reception data with each other and generating the transmission data.

(Supplementary Note 11)

A program for controlling an optical transmission device which causes a computer to perform:

a procedure in which transmission data is divided into a plurality of data and the plurality of data are outputted;

a procedure in which frequency bands of the divided transmission data are shifted so that the frequency bands do not overlap each other and the divided transmission data whose frequency bands are shifted are outputted as modulation signals;

a procedure in which an optical carrier is modulated with a signal in which the modulation signals are added; and

a procedure in which the modulated optical carrier is outputted as a signal light.

(Supplementary Note 12)

A program for controlling an optical reception device which causes a computer to perform:

a procedure in which coherent reception is performed by mixing signal lights in which divided transmission data are included in different optical carriers with a local light and a reception signal is outputted;

a procedure in which each of the divided transmission data included in the reception signal is extracted for each frequency band in which each of the divided transmission data is included and the extracted divided transmission data is outputted as reception data; and

a procedure in which the extracted reception data are coupled to each other and the transmission data is generated.

1. An optical transmission device comprising:
a division unit that divides transmission data into a plurality of data and outputs the plurality of data;
a frequency conversion unit that shifts a frequency band of the divided transmission data so that the frequency bands of the divided transmission data do not overlap each other and outputs the divided transmission data whose frequency band is shifted as a modulation signal; and
an optical modulation unit that modulates an optical carrier with a signal in which the modulation signals are added and outputs the modulated optical carrier as a signal light.

2. The optical transmission device described in claim 1 further including a coding unit that converts the divided transmission data into a signal corresponding to a modulation scheme of the optical modulation unit and outputs the converted signal to the frequency conversion unit, wherein
the coding unit generates a XI (inphase) signal corresponding to a first polarization X, a XQ (quadrature) signal whose phase is orthogonal to the phase of the XI signal, a YI signal corresponding to a second polarization Y orthogonal to the first polarization X, and a YQ signal whose phase is orthogonal to the phase of the YI signal and outputs these signals to the frequency conversion unit, and
a modulation scheme of the optical modulation unit is a polarization multiplexing phase modulation scheme in which X and Y polarizations are multiplexed each other.

3. An optical reception device comprising:
an optical receiver that performs coherent reception by mixing signal lights in which divided transmission data are included in different optical carriers with a local light and outputs a reception signal;
a frequency conversion unit that extracts each of the divided transmission data included in the reception signal for each frequency band in which each of the divided transmission data is included and outputs the extracted divided transmission data as reception data; and
a coupling unit that generates the transmission data by coupling the extracted reception data with each other.

4. The optical reception device described in claim 3 further including a decoding unit that decodes the signal outputted by the frequency conversion unit and generates the divided transmission data wherein
the optical receiver has a function to demodulate a polarization multiplexed phase modulation signal and outputs a XI′ (inphase) signal corresponding to a first polarization X′, a XQ′ (quadrature) signal whose phase is orthogonal to the phase of the XI′ signal, a YI′ signal corresponding to a second polarization Y′ orthogonal to the polarization X′, and a YQ′ signal whose phase is orthogonal to the phase of the YI′ signal to the frequency conversion unit as the reception signal.

5. An optical transmission-reception device comprising the optical transmission device described in claim 1 and an optical reception device,
wherein the optical reception device includes:
an optical receiver that performs coherent reception by mixing signal lights in which divided transmission data are included in different optical carriers with a local light and outputs a reception signal;
a frequency conversion unit that extracts each of the divided transmission data included in the reception signal for each frequency band in which each of the divided transmission data is included and outputs the extracted divided transmission data as reception data; and
a coupling unit that generates the transmission data by coupling the extracted reception data with each other.

6. An optical transmission system in which the optical transmission-reception devices described in claim 5 are arranged so as to face to each other, one of the optical transmission-reception devices transmits a signal light to the other of the optical transmission-reception devices, and the other of the optical transmission-reception devices receives the signal light.

7. An optical transmission system having a configuration in which the signal light transmitted by the optical transmission device described in claim 1 is received by an optical reception device,
wherein the optical reception device includes:
an optical receiver that performs coherent reception by mixing signal lights in which divided transmission data are included in different optical carriers with a local light and outputs a reception signal;
a frequency conversion unit that extracts each of the divided transmission data included in the reception signal for each frequency band in which each of the divided transmission data is included and outputs the extracted divided transmission data as reception data; and
a coupling unit that generates the transmission data by coupling the extracted reception data with each other.

8. An optical transmission system having a configuration in which the signal light transmitted by the optical transmission device described in claim 2 is received by an optical reception device,
wherein the optical reception device includes:
an optical receiver that performs coherent reception by mixing signal lights in which divided transmission data are included in different optical carriers with a local light and outputs a reception signal;
a frequency conversion unit that extracts each of the divided transmission data included in the reception signal for each frequency band in which each of the divided transmission data is included and outputs the extracted divided transmission data as reception data;
a coupling unit that generates the transmission data by coupling the extracted reception data with each other; and
a decoding unit that decodes the signal outputted by the frequency conversion unit and generates the divided transmission data, and wherein
the optical receiver has a function to demodulate a polarization multiplexed phase modulation signal and outputs a XI′ (inphase) signal corresponding to a first polarization X′, a XQ′ (quadrature) signal whose phase is orthogonal to the phase of the XI′ signal, a YI′ signal corresponding to a second polarization Y′ orthogonal to the polarization X′, and a YQ′ signal whose phase is orthogonal to the phase of the YI′ signal to the frequency conversion unit as the reception signal.

9. An optical transmission method comprising:
dividing transmission data into a plurality of data and outputting the plurality of data;
shifting frequency bands of the divided transmission data so that the frequency bands do not overlap each other;
outputting the divided transmission data whose frequency band is shifted as a modulation signal;
modulating an optical carrier with a signal in which the modulation signals are added; and
outputting the modulated optical carrier as a signal light.
